(19) United States
(12) Patent Application Publication
(10) Pub. No.: US 2026/0364557 A1
(43) Pub. Date: Nov. 19, 2026

(54) HIGH-TEMPERATURE REACTOR

(71) Applicant: Everllence SE, Augsburg (DE)

(72) Inventors: Rainer NOWAK, Metten (DE); Klaus EHMANN, Deggendorf (DE); Benedikt ACKERSCHOTT, Niederalteich (DE)

(21) Appl. No.: 19/487,778

(22) PCT Filed: May 3, 2024
(86) PCT No.: PCT/EP2024/062243

§ 371 Date: Nov. 25, 2025

(30) Foreign Application Priority Data
Jun. 1, 2023 (DE) 10 2023 114 369.7

(51) Int. Cl. B01J 8/08

(52) U.S. Cl. CPC B01J 8/087; B01J 2208/065

(57) ABSTRACT

In a tube bundle reactor for carrying out catalytic gas phase reactions, comprising reaction tubes (3) which are made of a material having a first thermal coefficient of expansion al, and comprising tube bases (5), (8) and a reactor casing (11) which are made of a material having at least one second thermal coefficient of expansion α2, where α2>1.13*α1 or α2<0.88*α1, the reactor casing (11) is formed in the axial direction by three casing portions (12, 13, 19), the first (12) of which is connected to the gas-inlet-side tube base (5) and the second (13) of which is connected to the gas-outlet-side tube base (8) and both (12), (13) are made of a material having the at least one second thermal coefficient of expansion α2, wherein between the first casing portion (12) and the second casing portion (13) a third casing portion (19) made of a material having a third thermal coefficient of expansion α3 is provided, where α3<=0.99*α2 if α2>1.13*α1, or where α3>=1.01*α2 if α2<0.88*α1. The invention also relates to methods for operation and uses of such a tube bundle reactor.

### CROSS REFERENCE TO RELATED APPLICATIONS

This is a U.S. national stage of Application No. PCT/EP2024/062243 filed May 3, 2024. Priority is claimed on German Patent Application No. DE 10 2023 114 369.7 filed Jun. 1, 2023, the contents of which are incorporated herein by reference.

### BACKGROUND OF THE INVENTION

### 1. Field of the Invention

The present disclosure relates to a tube bundle reactor and to a method for operating such a tube bundle reactor and uses of such a tube bundle reactor. It relates in particular to the production of carbon monoxide using a catalytic reverse water-gas shift (RWGS) reaction.

### 2. Description of the Related Art

It is known that tube bundle reactors are used for high-temperature processes, such as the RWGS reaction
CO₂+H₂>CO+H₂O ΔH_{R}=+41 kj/mol
   (with carbon dioxide (CO₂), hydrogen (H₂), carbon monoxide (CO), water (H₂O) and the reaction enthalpy (ΔH_{R})). Specifically, in this process, corrosion by metal dusting can occur on the gas side. On the heat transfer medium side, corrosion can likewise occur through aggressive heat transfer media. These attacks can be counteracted by materials adapted to the specific corrosion mechanisms. Frequently, these different materials have distinct thermal expansion coefficients, which can result in critical material stresses even when heating the reactor from ambient temperature to operating temperature.

Generally, the reaction tubes and the reactor casing consist of similar materials with similar thermal expansion coefficients. With a good inflow, a good heat transfer is achieved in the casing space of the tube bundle reactor through the heat transfer medium salt, so that the temperature of the reaction tubes and of the casing space differ only slightly from the temperature of the heat transfer medium. The mechanical stresses on the tube bundle reactor through different expansions as a consequence of different temperatures are thus minor. U.S. Pat. No. 4,559,207A relates to a boiling water tube bundle reactor for producing methanol with reaction tubes, which relative to the educt gas consist of a catalytically ineffective metallic material. A further characteristic of this material consists in that its thermal expansion coefficient almost coincides with that of the reactor casing material. Mixed ferritic-austenitic chromium steels are proposed as suitable materials for the reaction tubes, which can also be inertly coated or clad, if required.

Similarly, GB724452A describes a tube reactor in which the oxidation of olefins is favoured in particular by the use of reaction tubes of nickel-free chromium steel with a heat expansion coefficient which is slightly lower than that of the carbon steel of which the reaction vessel consists.

This is different in the load case when the reaction tubes and the reaction casing consist of materials with different thermal expansion coefficients. This case can occur when the reaction tubes, because of the corrosive properties of the reaction gas, have to consist of a particularly resistant material, but the reactor casing is not exposed to these conditions and accordingly can be embodied out of a more cost-effective material but which, however, has a different thermal expansion coefficient.

Different expansions of reaction tubes and reactor casing are absorbed in EP 1 113 238 A2 by a compensator in the reactor casing. A similar design is known from WO 2004/052525 A1 with a compensator in the reactor casing in the region of a ring channel. However, these designs are only possible at lower pressures or small reactor dimensions. The problem can also be solved by using materials of the same type, but this is expensive.

In US 2003/0173062A1, disadvantageous effects of thermal expansions in a heat exchanger reactor are minimised through different measures such as flow guide plates, through which the tubes are passed, insulation layers and fins. There, the deflection plates have a lower heat expansion coefficient than the tube bases.

WO 2009/092724 A1 relates to a tube reactor with nickel-containing cladding of the tube bases and the reaction tubes embodied out of a nickel-based material, in the case of which the outer casing of the reactor has a thickness which is sufficient for absorbing tensile forces occurring with a different expansion due to a temperature differential between tube and outer casing.

In WO 2008/115933 A1 a multi-stage method for producing hydrocarbons and alcoholic fuels using renewable energy sources is described, in the case of which tube bundle reactors for an RWGS process and a Fischer-Tropsch process are used. There, the RWGS tube bundle reactor is preferably heated with a liquid heat transfer medium which consists of a liquid alloy, liquid salt or an organic heat transfer medium. Design details of these tube bundle reactors are not disclosed. Examples for corresponding catalysts are stated for the different processes.

A similar method is published in WO 2022/263384 A1. The same relates to the production of only CO and is operated by single-stage gas recirculation. The recirculation gas is conditioned in the known manner by condensing-out water and separating the target components. The RWGS reactor preferably consists of a tube bundle reactor operated with liquid salt. The process gas generally has a temperature between 5° C. and 150° C. and a pressure in the range from 1 to 200 bar. Preferentially, the pressure is between 5 and 70 bar. As with all other pressure ratings within the scope of the publication present here, the pressure rating here relates to absolute pressure. Following the heating-up of the process gas, the same has a temperature between 200° C. and 700° C., preferentially between 450° C. and 600° C. prior to entering the RWGS reactor. Preferably, the reaction temperature is in a range between 500° C. and 600° C. Preferably, catalysts are used which suppress the methanization. The RWGS reactor preferably contains two catalyst beds, wherein the gas can be heated up in between. The heat transfer medium is preferably conducted in counterflow to the reaction gas and electrically heated outside the reactor. As advantage it is stated that compared with known high-temperature processes metal dusting or methanization are largely avoided through relatively low operating temperatures, so that more cost-effective materials can be used.

In WO 2007/108014 A1 a method for producing liquid fuels out of CO₂ and water is presented. There, the RWGS reaction forms an intermediate step for producing a reaction gas containing CO and H₂, with which via intermediate products such as methanol and DME (dimethyl ether), liquid fuels are finally produced. For the RWGS method, a catalytic tube bundle reactor is used which is operated at 400° C. and 5 bar. The conversion increases with other operating methods, such as for example, at 500° C. and 50 bar with an H₂/CO₂ ratio of 2:1 in the process gas. The reaction heat for the RWGS process originates from exothermic sub-processes.

Further, RWGS methods are known, for example, from WO 2022/129338 A1, WO 2021/062384 A1, WO 2003/070629 A1 or WO 2021/225643 A1.

In the study “conceptional and technical configuration of a development platform for power-to-liquid fuels”, downloadable at https://www.now-GMBH.de/wp-content/uploads/2021/08/EPP_final report.pdf, a demonstration plant for producing flow-based liquid fuels is proposed. An RWGS reactor used there is embodied in the known technology as natural/biogas-fired reformer, including waste heat and steam generating system and thus constitutes a plant configuration which is otherwise usual for the steam reforming of natural/biogas. The process is to be carried out at temperatures in the range from 700° C. to 1000° C. and at pressures of up to 30 bar when using popular catalysts. Preferentially, an inlet pressure of 27 bar and a temperature of 900° C. are used. Electrically heated reactors are considered not fully technically matured. A central problem with the RWGS method is the material attack by “metal dusting”. The mechanism of action of this type of corrosion has not been completely clarified yet. A prerequisite in each case is that a greatly carburizing gas composition is present, which is characterised by the carbon activity “a_{c}”. The critical temperature range is between approximately 400° C. and 900 °C. From approximately 800° C. to 900° C., metal dusting decreases again. Metal dusting is amplified by high pressure from approximately 5 to 10 bar or occurs only as from these conditions. The effect was observed in different processes in petrochemical plants, e.g. in the catalytic reformation, the ammonia and methanol production, in reduction plants and others. Synthetic gas is a typical corrosive gas for metal dusting. Synthetic gas, or also called syngas, is a basic raw material in the chemical industry with which a multiplicity of synthetic reactions are carried out. Syngas substantially consists of hydrogen (H₂), carbon monoxide (CO) and applicable, minor proportions of further substances such as carbon dioxide (CO₂), methane (CH₄) or steam (H₂O_{g}). During the corrosion process by metal dusting, elementary carbon and fine metal particles are formed. Iron, low and high-alloyed steels as well as cobalt or nickel-based alloys are susceptible, while nickel-based alloys are more resistant. Particularly resistant nickel-based alloys have a high proportion of chromium (Cr) and aluminium (Al) and minor proportions of silicon (Si) and sometimes also copper (Cu). Through these alloying components, protective oxide layers are formed. Apart from this, such alloys have a low iron content and have defined grain sizes. Newer developments are, for example, duplex steels. New alloys which are resistant to metal dusting are continuously developed.

In the article “Metal Dusting”, https://www.corrosionguru.com/wp-content/uploads/2017/12/metaldusting.pdf, different mechanisms of the metal dusting and materials resistant to the same are described.

The article “Development of materials resistant to metal dusting degradation”, Argonne National Laboratory, 2005, https://doi.org/10.2172/890559 shows the corrosion mechanisms of different iron-based alloys and nickel-based alloys. The carbon activity ac is comprehensively investigated dependent on the gas composition, the temperature and the pressure. The tests are conducted with different alloys at 482° C., 593° C. and 704° C. The metal dusting rate is highest at 593° C. In addition, it rises with rising pressure and rising exposure time. At atmospheric pressure and 593° C., metal dusting does not manifest itself with almost any alloy, however, it does so at 14.3 bar. At the elevated pressure, the degree of corrosion is greatly dependent on the alloy quality, but also the exposure time. The susceptibility of the material falls with rising alloying components of nickel, chromium and aluminium. These alloying components form protective layers of chromium and aluminium oxide. A very good resistance to metal dusting was determined with nickel-based materials from a quality of alloy 602°CA. A better resistance is exhibited by alloy 693. Alloy 601 is comparatively less resistant.

These results are confirmed in the publication wo 2013/182177 A1, where a similar nickel-chromium-aluminium alloy with good processability, creep strength and corrosion resistance is introduced. WO 2006/121561 A2 introduces a further resistant alloy.

WO 2022/253963 A1 relates to a method for converting a process gas containing CO₂ and H₂ into syngas in a two-zone endothermic heat exchange reactor with exothermic reactions in the first reaction zone and endothermic reactions in the second reaction zone. In the process, methane is formed in the first reaction zone, which at the high temperatures again reacts back into the second reaction zone. Optionally, the process gas can be preheated prior to entering the RWGS reactor. The heat transfer medium for introducing the reaction heat is preferably a gas. The application assumes that metal dusting occurs with gases containing CO and, in particular, when the same is cooled down. To avoid metal dusting, the reaction temperatures are consequently selected as high as possible. The reaction temperature in the first reaction zone is preferably above 500° C. (800° C., 900° C.-1000° C.) and in the second reaction zone above 600° C. and is up to 800 °C. The syngas can be combined directly with the heat transfer medium in different ways. The reaction heat to be introduced is provided by an electrical, a fired or an autothermic RWGS reactor. The pressure in the casing space is between 2 bar and 50 bar or between 50 bar and 200 bar. In the embodiment examples, the pressure is between 9.5 and 11.5 barg. When the heating gas of the casing side is combined with the reaction gas, the same pressure is present throughout the reaction space. The type of the reactor can, for example, be a conventional steam reformer. Materials which are resistant to metal dusting are not discussed in WO 2022/253963 A1.

Thus, it is known that in tube bundle apparatuses, different length expansions of pipes and apparatus casing can materialise as a consequence of different thermal expansion coefficients and/or as a consequence of different temperatures on the pipe side and the casing side. The different length expansions result in material stresses in the apparatus, which also have to be compensated for by suitable measures such as adequate wall thicknesses, compensators or suitable materials. There are, however, application cases in which certain materials with different thermal expansion coefficients are essential for the sake of corrosion resistance and the strength at high temperatures and in which measures known from the prior art can no longer be applied when the different length expansions exceed a certain dimension.

### SUMMARY OF THE INVENTION

One aspect of the invention is therefore based on forming a tube bundle reactor according to the generic term in such a manner that at temperatures between 450° C. and 650° C. and over-pressures between 5 bar and 50 bar, it can be operated so that the material stresses through different heat expansions as a consequence of different thermal expansion coefficients of reaction tubes and reaction casing remain in a permissible range and that the tube bundle reactor is still economically producible. A further object consists in configuring the tube bundle reactor so that endothermic gas phase reactions can be carried out with it, especially RWGS reactions and in particular gas phase reactions, in the case of which the reaction gas has highly carburizing properties and can lead to corrosion mechanisms such as metal dusting.

A tube bundle reactor according to one aspect of the invention satisfies, because of process-technical requirements, one of the conditions α₂>1.13*α₁ or α₂<0.88*α₁.

The reactor casing of the tube bundle reactor according to the invention is formed in the axial direction out of three casing portions, the first of which has an axial length LIA and is connected to the tube base on the gas inlet side and the second of which has an axial length L2A and is connected to the tube base on the gas outlet side, and which are both formed out of a material having the at least one second thermal expansion coefficient α₂. Between the first casing portion and the second casing portion, a third casing portion with a length L3 out of a material with a third thermal expansion coefficient α₃ is arranged, with α₃<0.99*α₂ for the case that α₂>1.13* α₁ or with α₃>1.01*α₂ for the case that α₂<0.88*α₁.

When α₂ is greater or smaller than α₁, the reactor casing and the reaction tubes expand differently at rising temperatures. This results in stresses for the apparatus parts, which can be managed with different methods from the prior art, for example, through suitably thick casing walls or through compensators. These methods come up to their limits when the ratio of the thermal expansion coefficients exceeds a certain limit value, which in the case of practise-relevant large tube bundle reactors with apparatus diameters in the order of magnitude of 6 m to 8 m is at α₂>1.13*α₁ or α₂<0.88*α₁. As from these ratios, uneconomical or technically not viable designs result with known design methods.

By way of the measures according to one aspect of the invention, tube bundle reactors can be produced in which the materials used are resistant to metal dusting on the gas side and resistant to salt corrosion on the casing side and therefore make possible a high conversion in the lower temperature working range of the RWGS reaction. The different materials for the reaction tubes and the reactor casing required for the sake of the corrosion and the economy result in different axial expansions with correspondingly severe material stresses, but which according to the invention, however, can be reduced by using different casing portions of materials with different thermal expansion coefficients to a permissible degree. With respect to process conditions and material employed, this results in optimal possibilities since the tube bundle reactor can be operated with minimum use of material at high temperatures and pressures. A tube bundle reactor according to the invention can be produced in orders of magnitude which with the known design methods are uneconomical or technically not feasible. Through the measures according to the invention, tube bundle reactors can be produced in which the materials used on the gas side are resistant to metal dusting and on the casing side resistant to salt corrosion and therefore make possible, for example, a high conversion in a lower temperature working range of the RWGS reaction. The different materials for the reaction tubes and the reactor casing required for the sake of the corrosion and the economy result in different axial expansions with correspondingly severe material stresses, but which according to the invention can be reduced to a permissible degree by using different casing portions of materials with different thermal expansion coefficients. With respect to process conditions and material use, this results in optimal possibilities since the tube bundle reactor can be operated with minimised use of material at high temperature and pressures. A tube bundle reactor according to the invention can be produced in orders of magnitude, which with the known design methods are uneconomical or technically not feasible.

In a preferred aspect, the reactor casing and the tube bases jointly have a mean axial thermal expansion coefficient αₘ=(α₂*(L1A+L1B+L2A+L2B)+α₃*L3)/(L1A+L1B+L2A+L2B+L3) with a ratio αₘ/α₁, which is in a range from 0.88 to 1.13, preferably in a range from 0.90 to 1.10 and particularly preferably in a range from 0.92 to 1.09. By selecting a material with a corresponding thermal expansion coefficient α₃ and the ratio of the sum of the axial lengths L1A, L1B, L2A, L2B to L3 a mean expansion coefficient αₘ is obtained, which satisfies the condition αₘ/α₁<=1.13 or αₘ/α₁>=0.88.

The ideal value for the ratio αₘ/α₁ is exactly 1.0. However, this cannot be maintained in most instances because of the design restrictions and the choice of available materials. When the ratio αₘ/α₁ remains within the claimed range limits, the material stresses resulting from the different axial expansions within the tube bundle reactor are smaller than the permissible material stresses at any point and at any time. The material stresses can occur when all parts of the tube bundle reactor during the heating-up to the operating temperature have the same temperature at any time or when different parts of the tube bundle reactor have different temperatures during the heating-up as a consequence of different heating.

The respective length expansions are calculated with the relationship

ΔL=α*ΔT*L0

with
ΔL [mm] length expansion
α [1/K] thermal expansion coefficient
ΔT [K] temperature change
L0 [mm] respective reference length

The material stresses resulting from this are obtained through the calculation formalisms known to the person skilled in the art. Employed are, for example, DIN EN 13445-3:2021-12, 13.59 or ASME BPVC. VIII. 1-2021, UHX-13LA], in particular the part UHX-13.6 from these.

In practical aspects, one endeavors to use as few as possible materials. Accordingly, it is opportune to use the material of the tube bases and of the casing portions following thereon, also for the reactor hoods. When, however, different materials are used, possibly also with different thermal expansion coefficients, the calculation equation for AM has to be expanded accordingly.

A known problem when welding different types of materials consists in that welded connections of workpieces of high-strength C-steel have to be heat-treated after the welding. This is not required in the case of stainless steel. Since the heat treatment of the complete tube bundle reactor is very expensive, one tries to avoid this, if possible.

When welding high-strength C-steel to stainless steel, a buffer layer of stainless steel each is applied to the weld edges of the middle casing portion and subsequently heat-treated if required. Heat treating this spatially strictly limited region causes only little expenditure. The weld seam edges of all casing portions now consist of stainless steel, which after the welding need no longer be heat-treated. Details regarding such methods are known, for example, from U.S. Pat. No. 2,963,129, WO2000/032350A1 or WO2015/091681A1 for different applications. They are additionally described, for example, in the regulatory works, ASME BPVC Sec. IX, QW-283.

In an advantageous aspect of the invention, α₂>1.13*α₁ and α₃<=0.99*α₂ and α₃<=α₁ applies.

Since stainless steel generally has a high thermal expansion coefficient, it generally results in that the thermal expansion coefficient α₂ from the first and second casing portion is greater than the thermal expansion coefficient α₁ of the reaction tubes α₂>α₁. For compensation, the thermal expansion coefficient α₃ of the third casing portion has to be smaller than: α₃<α₂. In a preferred embodiment, the same is maximally as great as the thermal expansion coefficient α₁ of the reaction tube material: α₃<=α₁.

By inserting a third casing portion with α₃<=0.99*α₂, the length expansion of the reactor casing altogether is diminished in the axial direction. On the other hand, the stainless steel of the first and second casing portion also expands to a greater degree in the radial direction than the third casing portion of C-steel. In a corresponding strength calculation, these effects are taken into account and the required wall thicknesses determined.

In the case of certain temperature and pressure ranges, syngas leads to metal dusting in the case of some materials. A further prerequisite is the so-called carbon activity. When a carbon activity of significantly more than one is present, metal dusting has to be expected. This prerequisite generally applies regarding the preferred operating conditions considered here. In a preferred embodiment, the reaction tubes are thus formed out of a material that is resistant to the corrosion properties Of the process gas with the chosen gas composition, the chosen pressure and the chosen temperature. The reaction tubes are preferably formed completely out of this corrosion-resistant material for safety reasons and for the sake of producibility.

In a favourable further development of the invention, the reaction tubes are formed out of a nickel-based alloy. Out of this material class, many different materials are known and basically usable for the reactor according to the invention. Particularly suitable are alloys which are selected from the materials alloy 601, alloy 602CA, alloy 693 or alloy 699XA or comparable. A “comparable material” in terms of the present publication is to mean a material which in other designation systems is classified as equivalent. Accordingly, the UNS material N06025 or the material number 2.4633-NiCr25FeAlY according to the German designation are, for example, comparable with the material alloy 602CA used here, wherein this designation is a shortened designation in general use for the complete designation “VDM® alloy 602CA”. Although the equivalent materials of other designation systems have a substantially same composition and same mechanical properties, but these can slightly differ from those of the reference material. The corrosion resistance of these materials increases in the stated order. These materials constitute a selection of the most advantageous materials currently available. The selection of the reaction tube material preferably takes place according to a fixed selection method in which, depending on the decisive parameters, the required quality of the material is determined. Through these methods, it is ensured that only the material quality is employed, which is really required for the respective application case present. In this way, the costs can be limited to the necessary level. The stated materials must on no account be understood as exclusive. They merely represent a preferred selection for the risk of metal dusting. In other applications, correspondingly other materials can be employed.

In many cases, the material alloy 602CA is used. The same constitutes a sound compromise between corrosion resistance and price. In certain cases, the material alloy 601 can also be employed when the risk of a material attack by metal dusting is low, for example, when only a low pressure is present or the probable operating time of the reactor is short, such as for example, in the case of a laboratory test reactor. Materials with high corrosion resistance such as alloy 683 or alloy 699A are employed in particular when this is necessary for the sake of the peripheral conditions. The selection is not exclusive. New alloys are continuously being developed, which can be equally employed in the tube bundle reactor according to the invention.

In a preferred aspect of the invention the tube bases, the gas inlet hood, the gas outlet hood, the first and the second casing portion are formed out of a highly heat-resistant stainless steel, for example, material SS316 or comparable, and the third casing portion is formed out of a highly heat-resistant low-alloy C-steel, for example, material SA387 Gr.22C1.2. The material SS316, or comparable, is characterised to a particular degree by the combination of the properties of high-temperature resistance, absence of heat treatment, corrosion resistance and price.

The thermal expansion coefficient of the material SA387 Gr.22C1.2, or comparable, for the third casing portion is lower than that of the first and second casing portion, and still lower than that of the reaction tube material. In addition to this, it has good strength values even at high temperatures and is comparatively cost-effective. Thus, one endeavors to make the portion of the casing length L3 as large as possible. On the other hand, the lengths L1A and L2A have to be so large that there is space for the ring channels in this region. For the expansion compensation, adequate distance has to be present in the direction of the casing portion located in between. Thus, a soft transition is achieved in which radially different expansions can be compensated for in the region of the weld seam. In addition, the applicable regulatory works have to be observed.

An approximation to the ideal state can therefore be achieved, for example, by the following material combination:

Nickel-based material alloy 602CA for reaction tubes:
α_{602CA}=14.8*10⁻⁶*K⁻¹

Stainless steel SS316 for tube bases, etc.:
α_{SS316}=18.64*10⁻⁶*K⁻¹

C-steel SA387Gr.22C1.2 for third casing portion:
α_{S387}=14.48*10⁻⁶*K⁻¹

In an embodiment not according to the invention, no third casing portion is present. Assuming the same lengths for the reaction tubes on the one hand, and for the reactor casing and the tube bases together, on the other hand, α₁=α_{602CA} and αₘ=α₂ with this material combination. Thus, αₘ/α₁=1.26 and is thus outside the range of the ratios of the thermal expansion coefficients according to the invention. With this peripheral condition, the permissible material characteristic values are exceeded when running up the tube bundle reactor to operating temperature and during the operation under pressure load at the latest, so that plastic deformations and even failure can occur.

In one aspect of the invention, a third casing portion of C-steel is therefore used. In this example, the same has a thermal expansion coefficient that is lower than that of the first and second casing portion and which is even lower than that of the reaction tubes.

However, the other case can also occur in which the second thermal expansion coefficient α₂ is lower than the thermal expansion coefficient α₁ of the reaction tubes, and the third thermal expansion coefficient α₃ is higher than the second thermal expansion coefficient α₂. This can be the case when the reaction tubes consist of stainless steel and the reactor casing of a C-steel. In this case, the third casing ring with the length L3, for example, is preferably embodied out of a material having a similar thermal expansion coefficient as the reaction tubes, wherein in this case a material from the group of stainless steels is opportune.

Advantageously, the tube bases, the gas inlet hood and/or the gas outlet hood on the gas side are clad with a nickel-based material from the group of the materials for the reaction tubes. The type of the nickel-based material is determined analogously to the selection method for the material of the reaction tubes. For example, stainless steel is determined as material for the gas inlet hood, the gas outlet hood and the tube bases. Subsequently, it is checked whether this material is susceptible to metal dusting with the operating conditions. Generally, the process gas has a lower temperature than the reaction temperature. The reaction equilibrium of the RWGS reaction under these conditions is rather on the side of the educts, i.e. at CO₂ and H₂. Thus, the susceptibility to metal dusting consequently falls. Depending on its properties, the selected material can either be used without further protective measures, or it is protected with a cladding resistant to metal dusting. The resistance can be lower than with the following tube bundle reactor parts, which are exposed to a higher carbon activity through a higher temperature, a higher pressure and a more aggressive gas composition. A cladding method is, for example, the explosion cladding. The tube base is generally always clad, preferably with the material of the reaction tubes. This makes possible a simple welding of the reaction tubes to the tube base.

Preferably, the third casing portion is clad with a material that is corrosion-resistant to the heat transfer medium, wherein this cladding extends over an axial length in a range between 1 and 100 mm into the adjacent first and second casing portion and is tightly connected with each of these. The use of carbonate salt melts allows a process control at high temperatures. In the region of the upper application limit the salt melt, however, becomes highly corrosive through decomposition reactions into oxides in connection with many materials at the specified temperature. Although the material of the third casing portion has good strength values at high temperatures, but is not generally corrosion-resistant to carbonate salt melts, and is therefore protected from the heat transfer medium with a cladding. Generally, the same material as that used for the first and the second casing portion is also employed. Preferably, the material SS316 or a higher-rated quality is employed. The cladding takes place with a method known from the prior art.

In tube bundle reactors for the most important exothermic gas phase reactions, the tube inner diameter is mostly within a range between 21 mm and 26 mm. These tube diameters result in a cooling area density, in which the reaction heat in the case of hotspots, which often occur in exothermic gas phase reactions, can be securely dissipated. Such hotspots do not occur in endothermic gas phase reactions, so that in this case the heating area density can be reduced to a certain degree by enlarging the tube inner diameter. Thus, the number of tubes and the manufacturing costs for the tube bundle reactor are reduced. In a further embodiment according to the invention, the reaction tube inner diameter is thus in a range within 30 to 60 mm. Larger reaction tube inner diameters are possible, but it has to be ensured in the process design that the heat transfer is still adequate. In an advantageous aspect, a tube bundle reactor according to the invention, comprises at least one E-heater constructed in modular design for heating the heat transfer medium, wherein the term “E-heater” is to mean an electrically operated heater. This E-heater is preferably arranged parallel next to a circulating pump of the tube bundle reactor. The heat transfer medium is conducted from the delivery side of the circulating pump to the E-heater and from there conducted to a point upstream of the circulating pump. The heat transfer medium flow through the E-heater is regulated by an optional regulating valve. If required, a further E-heater is connected downstream of the at least one first E-heater. Through the modular construction of the E-heater, a capacity expansion is easily possible. Preferably, these further E-heaters are arranged parallel to the first E-heater. This facilitates the accessibility for installation and maintenance operations, in particular as the heater bars are concerned. Preferably, all E-heaters are operated with regeneratively produced electric power in order to achieve an emission-free operation.

In a preferred aspect, the reaction temperatures are within a range from 450° C. to 650° C. In an even more preferred embodiment, these temperatures are within a range from 500° C. to 550° C. With respect to a possible high conversion, this temperature range is sufficiently high, but on the other hand, still so low that there is still an adequate choice of permissible and economical materials for this. At lower temperatures, the corrosion tendency both on the gas side and also on the heat transfer medium side falls, and the thermal and mechanical stress on the tube bundle reactor falls, but the conversion and the product yield also falls as a result. The opposite effects are obtained at temperatures which go beyond the upper temperature limit.

Advantageously, the pressure in the gas space is within a range of 5 bar absolute to 50 bar absolute, and even more preferred within a range from 10 bar absolute to 35 bar absolute. In these pressure ranges, there is an optimum with respect to, as large as possible, a mass throughput and large conversion on the one side and with respect to a limited structural expenditure on the other side. The structural expenditure results primarily from the mechanical stress which results in corresponding wall thicknesses. On the other hand, the requirements in terms of the material quality increase since the corrosive properties of the process gas are amplified with rising pressure.

In a further preferred embodiment, a melt of a mixture of carbonate salts or of a mixture of nitrate and nitrite salts, preferably solar salt, are used as heat transfer medium.

A salt melt of a mixture of nitrates and nitrites has proved itself as heat transfer medium in tube bundle reactors in many cases. Known is a ternary eutectic salt mixture designated HITEC™ of 7% NaNO3, 53% KNO3 and 40% NaNO2 with a melting point of 142° C. and a process range up to 540° C. In the upper temperature range, decomposition processes commence. In the case of solar power plants, “solar salt” is often employed, a mixture of 60% NaNO3 and 40% KNO3. The melting point in this case is approximately 240° C. and the application limit is around 600° C. The decomposition can be mitigated with protective gas and additional application of pressure.

It is known that hydrogen diffuses through metals. The diffusion flow is dependent on the pressure, the temperature and the type of the metal. When the nitrates/nitrites of a heat transfer medium salt decompose, forming oxygen, the gas atmosphere above the heat transfer salt has to be adequately purged in order to prevent the formation of an explosive atmosphere. Nitrate salt mixtures are, thus, basically suitable as heat transfer medium for the tube bundle reactor according to the invention for as long as no process gases with hydrogen components are used and for as long as the operating temperatures are not too high.

For reasons of higher thermal resistance, a melt of a mixture of carbonate salts is preferably employed for higher operating temperatures. However, any other compositions can also be used when this is practical for the application case. Advantageously, the carbonate salt melt is overlayed with a protective gas of CO₂.

A tube bundle reactor according to the invention is suitable to a particular degree for processes in which the reactor casing and the reaction tubes are exposed to different stresses which result, for example, from high operating pressures in the process gas, high temperatures or materials with different physical properties. It is suitable in particular for endothermic catalytic gas phase reactions.

A tube bundle reactor according to the invention is preferably used for conducting a catalytic gas phase reaction, which is selected from the production of styrene, formaldehyde, methylethylketone (MEK), cyan hydrogen, the dehydration of alkanes, the dehydration of alcohols, the reverse water-gas-shift reaction (RWGS), the steam reforming of methane or ethanol, the cracking of ammonia, methane or methanol, the catalytic naphtha reforming to a mixture of the aromatic hydrocarbons benzol, toluol and the three xylol isomers (BTX aromats), the oxidative coupling of methane (OCM), and the production of acyteldehyde, benzol, acrylonitrile, nitric acid, methyl mercaptan, the oxidation of sulphur dioxide into sulphur trioxide and the production of kerosene out of methanol via the olefin synthesis. In the case of endothermic reactions, the required reaction heat is primarily provided by combusting fossil fuels to date. In the tube bundle reactor according to the invention, the required reaction heat is preferably supplied to the process gas through regeneratively produced electric current via an E-heater and a heat transfer medium as intermediate medium.

A tube bundle reactor according to one aspect of the invention is particularly suitable for a process in which the catalytic gas phase reaction is formed out of the reverse gas shift reaction for producing CO. The CO₂ necessary in this reaction can be extracted up to a certain degree of biogenic sources, such as biogas, carbon-containing wastes or bi-products of many industrial processes. A further possibility consists in the separation of the ambient air. This method involves a greater expenditure, but this source is available everywhere and practically unlimited. The further required hydrogen is preferably extracted with an electrolyser, which splits water into hydrogen and oxygen. For operating the plants for separating CO₂ and also for extracting H₂, regeneratively extracted electric current, for example, from wind power or photovoltaic is preferably used.

### BRIEF DESCRIPTION OF THE DRAWINGS

In the following, the invention is explained in more detail by way of the figures. There it shows:

FIG. 1: is a longitudinal section through an exemplary embodiment of a tube bundle reactor;

FIG. 2: is a plan view of the exemplary embodiment from FIG. 1 with circulating pumps and E-heaters; and

FIG. 3: is a longitudinal section along line A-B in FIG. 2 through a circulating pump and two E-heaters.

### DETAILED DESCRIPTION OF THE PRESENTLY PREFERRED EMBODIMENTS

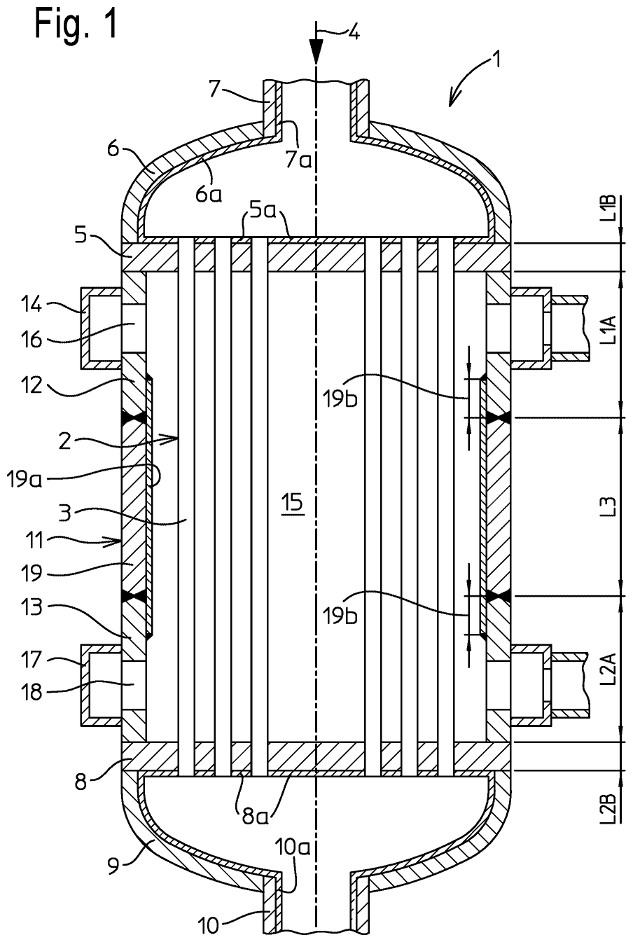

FIG. 1 shows a longitudinal section through a preferred embodiment of a schematically shown tube bundle reactor 1 for carrying out catalytic gas phase reactions. For the sake of clarity, usual peripheral units such as circulating pumps, coolers, heaters, and the like are not shown here. The tube bundle reactor 1 comprises a tube bundle 2, catalyst-filled reaction tubes 3, which are formed out of a material with a first thermal expansion coefficient α₁, and which are flowed through by a process gas 4. In this example, the process gas 4 is conducted through the tube bundle reactor 1 from the top down. A flow routing from the bottom up is equally possible. In this case, the following designations dependent on the flow direction change accordingly.

At their gas inlet-side ends, the reaction tubes 3 open into a gas inlet-side tube base 5 and are tightly connected to the same at their ends. The tube base 5 is spanned by a gas inlet hood 6 with a gas inlet line 7 and tightly connected to the gas inlet hood 6. The type of connection is dependent on the respective application case. At larger pressures approximately from 10 bar, or when a hermetic seal is required, tube bases 5 and gas inlet 6 are preferably welded together, but a flanged connection is basically also possible. At their gas outlet-side ends the reaction tubes 3 terminate in a gas outlet-side tube base 8 and are tightly connected to the same at their ends. The gas outlet-side tube base 8 is spanned by a gas outlet hood 9 with a gas outlet line 10 and tightly connected to the gas outlet hood 9. The statements as for the gas inlet side apply analogously to the gas outlet-side types of connection.

The tube bases 5, 8, the gas inlet hood 6, the gas inlet line 7, the gas outlet hood 9 and the gas outlet line 10 are clad on the gas side with a nickel-based material from the group of the materials for the reaction tubes 3 (5a, 8a, 6a, 7a, 9a, 10a).

The tube bundle 2 is surrounded by a multi-part reactor casing 11, which is tightly connected to the upper tube base 5 on the gas inlet side and to the lower tube base 8 on the gas outlet side. All parts of the tube bundle reactor 1 are preferably connected to one another by welded connections.

Preferably, a highly heat-resistant stainless steel is used as material for the tube bases 5, 8, the gas inlet and gas outlet hoods 6, 9 and for the directly adjoining casing portions 12, 13.

The reactor casing 11 is s formed out of a first casing portion 12 with an axial length L1A, which is connected to the upper tube base 5, and out of a second casing portion 13 with an axial length L2B, which is connected to the lower tube base 8. The upper tube base 5 has a thickness L1B, the lower tube base 8 a thickness L2B. The first and the second casing portion 12, 13 are formed out of a material with a second thermal expansion coefficient α₂. The first casing portion 12 is surrounded by a first, upper ring channel 14 in the vicinity of the upper tube base 5 for discharging a heat transfer medium out of the casing space 15 of the tube bundle reactor 1 through openings 16 in the first casing portion 12. Analogously, the second casing portion 13 is surrounded by a second, lower ring channel 17 in the vicinity of the lower tube base 5, for introducing the heat transfer medium into the casing space 15 through openings 18 in the second casing portion 13. The heat transfer in the casing space 15 from the heat transfer medium to the reaction tubes 3 is optimised by known flow guiding devices which are not shown here. A flow control from the top down is equally possible. Structurally, the units connected to the tube bundle reactor have to be suitably adapted in this case.

Between the first and the second casing portion 12, 13 a third casing portion 19 with an axial length L3 and a third thermal expansion coefficient α₃ is inserted. The second thermal expansion coefficient α₂ of the first and second casing portion 12, 13 is greater than the thermal expansion coefficient α₁ of the reaction tubes 3 and the third thermal expansion coefficient α₃ is smaller than the thermal expansion coefficient α₂ of the first and second casing portion 12, 13 and preferably even smaller than the thermal expansion coefficient α₁ of the reaction tubes 3.

The ratio αₘ/α₁ is in a range from 0.88 to 1.13, preferably in a range from 0.90 to 1.10 and very preferably in a range from 0.92 to 1.09. Thus, αₘ is the mean thermal expansion coefficient of the portions L1A, L1B, L2A, L2B and L3 with αₘ=(α₂*(L1A+L1B+L2A+L2B)+α₃*L3)/(L1A+L1B+L2A+L2B+L3).

Through the stated ratio αₘ/α₁, the individual length expansions are lower than predetermined maximum values in each case, with which the material stresses of the tube bundle reactor 1 at any point and at any time are smaller than the permissible material stresses.

The first length expansions occur during the heating-up of the tube bundle reactor 1 from ambient temperature to operating temperature. During the heating process it has to be ensured that the time change of the temperature does not exceed a predetermined maximum value, so that no material damage through length expansions that are very different locally, occurs. Further different length expansions occur when the pressure in the gas space is increased to the operating pressure. Such load cases are taken into account as part of the strength calculation. The third casing portion 19 is clad with a material 19a that is corrosion resistant to the heat transfer medium, wherein this cladding 19a extends over an axial length 19b in a range between 1 and 100 mm into the adjacent first and second casing portion 12, 13 and is tightly connected to the same in each case.

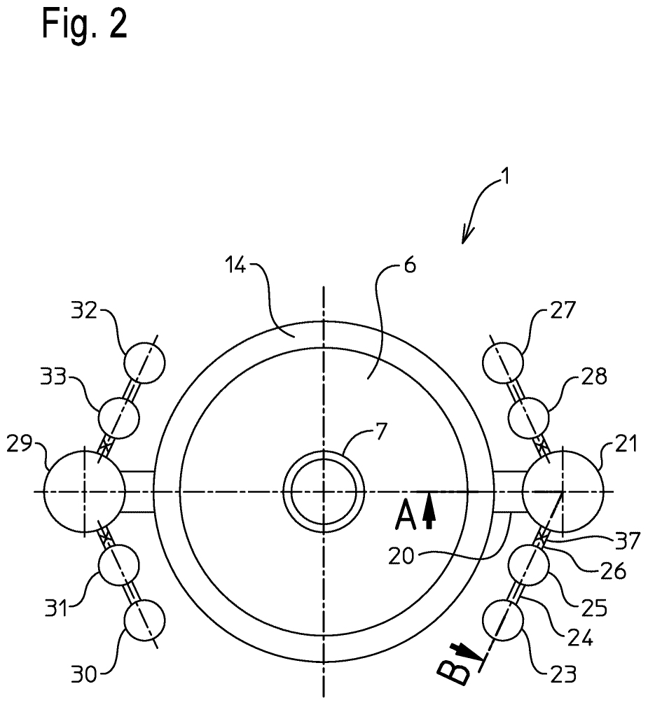

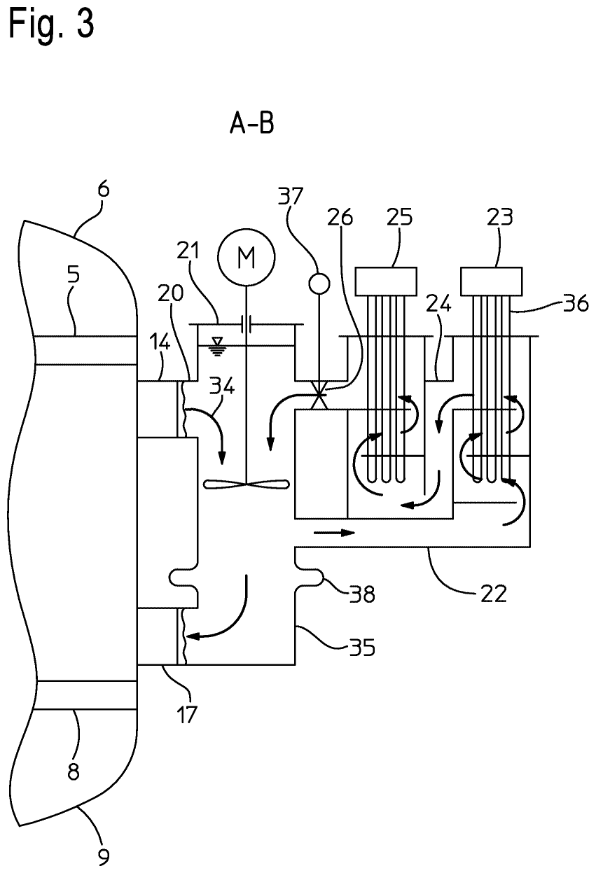

The plan view represented in FIG. 2 shows the gas inlet line 7, which leads into the gas inlet hood 6. On the right side, a connecting line 20 leads from the upper ring channel 14 to a first circulating pump 21. From the same, a connecting line 22 shown in FIG. 3 leads to a first E-heater 23, which in turn is connected by a connecting line 24 to a second E-heater 25. This E-heater 25 in turn is connected by a connecting line 26 with the circulating pump 21. A third E-heater 27 and a fourth E-heater 28 are connected to these two E-heaters 23, 25 in mirror image. In the same way, four further E-heaters 30, 31, 32 and 33 are connected to a circulating pump 29 located opposite. The number of the E-heaters depends on the heat requirement of the respective tube bundle reactor 1. It can be reduced or increased. The E-heaters 23, 25, 27, 28, 30, 31, 32, 33 are identical regarding their basic structure, i.e. of modular design. This simplifies the expenditure for design and construction and reduces the costs. All E-heaters 23, 25, 27, 28, 30, 31, 32, 33 are connected to the tube bundle reactor 1 by supports which are not shown here.

FIG. 3 shows a longitudinal section along the section line A-B entered in FIG. 2. The circulating pump 21 delivers the heat transfer medium 34 coming from the upper ring channel 14 downwards into the lower ring channel 17. From the lower pump housing 35, a connecting line 22 leads to the first E-heater 23. In the same, the heat transfer medium 34 is heated by electrically operated heating candles 36 and flows, likewise under the effect of guide plates, upwards. The heat transfer medium 34 flows via a vertical connecting channel 24 downwards into the inlet of the second E-heater 25, which is flowed through analogously to the first E-heater 23. The E-heaters 23, 25 are preferably identical in design so that a modular design according to FIG. 2 is easily possible. The heat transfer medium flow through the E-heater unit is regulated by an optional regulating valve 37. For accommodating the change in length of the reactor, the pump housing 35 preferably contains a compensator 38. The shown arrangement must on no account be considered restrictive. Depending on application case, the design in terms of the invention can be modified by the person skilled in the art. Accordingly, the regulating valve can be arranged, for example, between the first and second E-heater or the E-heaters can, in the plan view, not be arranged along a line but, for example, triangularly. Furthermore, the E-heaters can be arranged in parallel, in line or in a combination thereof as appropriate.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment Of the invention may be incorporated in any other disclosed or described or suggested form or embodiment as a general matter of design choice. It is the intention, therefore, to be limited only as indicated by the scope of the claims appended hereto.

1.-14. (canceled)

15. A tube bundle reactor configured to carry out catalytic gas phase reactions, comprising:
a bundle of reaction tubes, which are formed out of a material with a first thermal expansion coefficient α₁ and which in an operating state are catalyst-filled, are flowed through by a process gas, and flowed about by a heat transfer medium;
a gas inlet hood having a gas inlet line;
a gas inlet-side tube base with an axial dimension L1B, which is tightly connected to respective gas inlet-side ends of the reaction tubes and through which the reaction tubes lead into the gas inlet hood, wherein the gas inlet hood spans the gas inlet-side tube base and is tightly connected to the gas inlet-side tube base;
a gas outlet hood having a gas outlet line;
a gas outlet-side tube base with an axial dimension L2B, which is tightly connected to respective gas outlet-side ends of the reaction tubes and through which the reaction tubes lead into the gas outlet hood, wherein the gas outlet hood spans the gas outlet-side tube base and is tightly connected to the gas outlet-side tube base;
a reactor casing, which surrounds the bundle of reaction tubes and is connected to the gas inlet-side tube base and the gas outlet-side tube base, wherein the tube bases, and/or the reactor casing are formed out of a material with at least a second thermal expansion coefficient α₂, wherein:
α₂>1.13*α₁ or α₂<0.88*α₁,
wherein the reactor casing is formed out of three casing portions in an axial direction,
wherein:
a first casing portion of the three casing portions has an axial length L1a and is connected to the gas inlet-side tube base and is formed out of a material with the at least one second thermal expansion coefficient α₂,
a second casing portion of the three casing portions has an axial length L2A and is connected to the gas outlet-side tube base and is formed out of the material with the at least one second thermal expansion coefficient α₂, and
a third casing portion of the three casing portions is arranged between the first casing portion and the second casing portion and formed out of a material with a third thermal expansion coefficient as and an axial length L3 is present, with:
α₃<=0.99*α₂ for α₂>1.13*α₁ or
α₃>=1.01*α₂ for α₂<0.88*α₁.

16. The tube bundle reactor according to claim 15, wherein the reactor casing and the tube bases jointly have a mean axial thermal expansion coefficient αₘ where:
αₘ=(α₂*(L1A+L1B+L2A+L2B)+α₃*L3)/(L1A+L1B+L2A+L2B+L3),
wherein a ratio αₘ/α₁ which is in a range from 0.88 to 1.13.

17. The tube bundle reactor according to claim 15, wherein α₂>1.13*α₁ and α₃<=0.99*α₂ and α₃<=α₁.

18. The tube bundle reactor according to claim 15, wherein the reaction tubes are formed out of a material which is resistant to corrosion properties of the process gas with a chosen gas composition, a chosen pressure, and a chosen temperature.

19. The tube bundle reactor according to claim 18, wherein the reaction tubes are formed out of a nickel-based alloy selected from: alloy 601, alloy 602CA, alloy 693, alloy 699XA, and comparable.

20. The tube bundle reactor according to claim 15, wherein the tube bases, the gas inlet hood, the gas outlet hood, the first casing portion, and the second casing portion are formed out of a highly heat resistant stainless steel, and the third casing portion is formed out of a highly heat resistant low-alloy C-steel.

21. The tube bundle reactor according to claim 19, wherein the tube bases, the gas inlet hood and/or the gas outlet hood are clad on a gas side with a nickel-based material from the materials for the reaction tubes.

22. The tube bundle reactor according to claim 15, wherein the third casing portion is clad with a material that is corrosion-resistant to the heat transfer medium, wherein the cladding extends over an axial length in a range between 1 and 100 mm into adjacent first and second casing portions, and is tightly connected to these in each case.

23. The tube bundle reactor according to claim 15, wherein an inner diameter of the reaction tube is in a range from 30 to 60 mm.

24. The tube bundle reactor according to claim 15, further comprising:
at least one modularly constructed E-heater configured to heat the heat transfer medium.

25. A method for operating a tube bundle reactor having:
a bundle of reaction tubes, which are formed out of a material with a first thermal expansion coefficient α₁ and which in an operating state are catalyst-filled, are flowed through by a process gas, and flowed about by a heat transfer medium;
a gas inlet hood having a gas inlet line;
a gas inlet-side tube base with an axial dimension L1B, which is tightly connected to respective gas inlet-side ends of the reaction tubes and through which the reaction tubes lead into the gas inlet hood, wherein the gas inlet hood spans the gas inlet-side tube base and is tightly connected to the gas inlet-side tube base;
a gas outlet hood having a gas outlet line;
a gas outlet-side tube base with the axial dimension L2B, which is tightly connected to respective gas outlet-side ends of the reaction tubes and through which the reaction tubes lead into the gas outlet hood, wherein the gas outlet hood spans the gas outlet-side tube base and is tightly connected to the gas outlet-side tube base;
a reactor casing, which surrounds the bundle of reaction tubes and is connected to the gas inlet-side tube base and the gas outlet-side tube base, wherein the tube bases, and/or the reactor casing are formed out of a material with at least a second thermal expansion coefficient α₂,
wherein:
α₂>1.13*α₁ or α₂<0.88*α₁,
wherein the reactor casing is formed out of three casing portions in an axial direction,
wherein:
a first casing portion of the three casing portions has an axial length L1a and is connected to the gas inlet-side tube base and is formed out of a material with the at least one second thermal expansion coefficient α₂,
a second casing portion of the three casing portions has an axial length L2A and is connected to the gas outlet-side tube base and is formed out of the material with the at least one second thermal expansion coefficient α₂, and
a third casing portion of the three casing portions is arranged between the first casing portion and the second casing portion and formed out of a material with a third thermal expansion coefficient α₃ and an axial length L3 is present, with:
α₃<=0.99*α₂ for α₂>1.13*α₁ or
α₃>=1.01*α₂ for α₂<0.88*α₁,
wherein reaction temperatures are within a range from 450° C. to 650° C.

26. The method according to claim 25, wherein a pressure in a gas space is within a range from 5 bar absolute to 50 bar absolute.

27. The method according to claim 25, wherein a heat transfer medium is a melt of a mixture of carbonate salts or of a mixture of nitrate and nitrite salts, or solar salt.

28. The tube bundle reactor according to claim 15, wherein the tube reactor is configured to carry out a catalytic gas phase process, which is selected from:
a production of styrene, formaldehyde, methylethylketone, cyan hydrogen,
a dehydration of alkanes,
a dehydration of alcohols,
a reverse water-gas-shift reaction,
a steam reforming of methane or ethanol,
a cracking of ammonia, methane or methanol,
a catalytic naphtha reforming to a mixture of aromatic hydrocarbons benzol, toluol and a three xylol isomers (BTX aromats),
an oxidative coupling of methane,
a production of acyteldehyde, benzol, acrylonitrile, nitric acid, methyl mercaptan,
an oxidation of sulphur dioxide into sulphur trioxide and
a production of kerosene out of methanol via olefin synthesis.

29. The tube bundle reactor according to claim 16, wherein the ratio αₘ/α₁ is in a range from 0.90 to 1.10.

30. The tube bundle reactor according to claim 16, wherein the ratio αₘ/α₁ is in a range from 0.92 to 1.09.

31. The tube bundle reactor according to claim 20, wherein:
the highly heat resistant stainless steel is one of material SS316, or comparable, and
the highly heat resistant low-alloy C-steel is one of material SA387 Gr.22Cl.2, or comparable.
